(19) United States
(12) Patent Application Publication
(10) Pub. No.: US 2017/0228739 A1
(43) Pub. Date: Aug. 10, 2017

(54) Method and System for Providing Digital Product Information to a User of a Kitchen or Household Appliance

(71) Applicant: Electrolux Appliances Aktiebolag, Stockholm (SE)

(72) Inventors: Marcello Massaroni, Forli (IT); Irma Rustemi, Rothenburg ob der Tauber (DE); Ulrich Schieber, Rothenburg ob der Tauber (DE)

(21) Appl. No.: 15/315,113

(22) PCT Filed: Jun. 24, 2015
(86) PCT No.: PCT/EP2015/064173

§ 371 Date: Nov. 30, 2016

(30) Foreign Application Priority Data
Jul. 21, 2014 (EP) 14177868.8

(51) Int. Cl. G06Q 30/00; G06F 17/30; G06K 19/06

(52) U.S. Cl. CPC G06Q 30/01; G06K 19/06028; G06F 17/30879

(57) ABSTRACT

A method for providing digital product information about an appliance includes supporting by an ordering system an order process of the appliance, during which a buyer places an order for the appliance and accepts to receive digital product information about the appliance. In an assembling process or packaging process of the ordered appliance, the appliance or its packaging is provided with access information that indicates how to access the digital product information. The appliance can display the access information. A product information system supports accessing of the digital product information about the appliance by a buyer or product information recipient based on the access information. The product information system allows access to the digital product information via the Internet.

Generally, the present invention relates to the field of kitchen or household appliances. More specifically, the present invention relates to a method and a system for providing digital product information to a user of a kitchen or household appliance.

### BACKGROUND OF THE INVENTION

Today, kitchen appliances or household appliances, for example hobs, ovens, washing machines, dryers or dishwashers for use in professional kitchens or for use in private household kitchens as well as further household appliances, for example vacuum cleaners, air condition devices, hair dryers etc., are still delivered to the end consumer with documentation, in general product information, as a printed leaflet or booklet. Surprisingly, manufacturers of kitchen or household appliances still deliver product information in printed form, although digital product information has been available at download servers in the internet for some years already. Since it can be guessed that billions of pages are printed and delivered as user manuals of domestic appliances every year there appears to be a major unsolved environmental and economic problem that has not been effectively addressed for many years.

Therefore, the present inventors decided to investigate thoroughly why essentially all manufacturers of kitchen and household appliances today still prefer to deliver printed user manuals together with the appliances of their production rather than to rely on the already generally available internet as the main channel to distribute product information to their customers. An important result of that investigation was that manufacturers are concerned that essential security and environmental information that is specific for a given kitchen or household appliance of their production will safely reach each consumer. In fact, there are strict legal regulations in essentially all countries that require that manufacturers have to secure that every end user will receive certain product information, specifically safety and environmental information which is often specific for a given appliance.

Surprisingly, the inventors of the present invention have found that by means of the digital product information available today in the Internet the manufacturer of kitchen or household appliance are presently not able to secure in a legally safe way that each user will obtain the required product specific information. One partial problem is that still not all customers have ready access to the Internet and to digital product information, e.g. via a smartphone or a tablet computer. Another partial problem is that no reliable routines have been established yet in the market that would allow to provide consumers with product information in a safe way and that would therefore allow manufacturers to deliver their appliances without any written product information while avoiding any undue legal risks. So, there exists the still unsolved problem which has a major environmental and economic impact that kitchen or household appliances are today still delivered for safety and legal reasons with printed product information which has also to be provided in a plurality of languages in order to make sure that every user is able to obtain product information in a suitable language, and which requires using on a global scale a huge amount of paper which often may even not be read by the end user.

In the present document, the phrases “user”, “buyer” and “product information recipient” are synonymously used, i.e. product information recipient may be any person which uses the kitchen or household appliance, for example, the buyer of said kitchen or household appliance.

### SUMMARY OF THE INVENTION

It is an objective of the present invention to provide a cost-efficient and environment-friendly and legally safe method for making product information available to a user, in particular buyer, of a kitchen or household appliance. In addition, a corresponding system for providing product information to a user, in particular buyer, of a kitchen or household appliance shall be provided.

The objective is solved by the features of the independent claims. Preferred embodiments in particular result the dependent claims and the following description. If not explicitly indicated otherwise, embodiments of the invention can be freely combined with each other.

According to a first aspect of the invention, the invention relates to a method of providing a user or buyer of a household appliance, in particular electronic appliance, for example implemented as an electronic domestic or kitchen appliance, access to digital product information about the household appliance. A second aspect of the invention is related to a corresponding system.

Embodiments that may be applied to the method and system are given in connection with the following description of exemplary embodiments.

According to embodiments, a sensor readable tag associated with, in particular fixed or attached to, an appliance is provided for being presented to a user, for example buyer, of the appliance.

The sensor readable tag providing, for example by exposing, for example on a surface and/or on a readable storage, a data-link for electronically accessing, via a network, digital product information specifically related to the appliance. The digital product information may for example comprise a user guide or user manual or other types of information related to the appliance.

The sensor readable tag may be mechanically fixed on or printed on a surface, in particular outer surface, of the appliance and/or a packaging item, in particular outer packaging item, used for packaging the appliance in connection with delivery.

The sensor readable tag may comprise as the data-link an optically and/or electronically readable item which, for example, may be provided as an imprint or as electronic data stored on a memory of the sensor readable tag.

As an optical sensor, a camera, for example a camera of a, e.g. mobile, user or client device, such as a smartphone, tablet computer and the like, may be provided. The sensor readable tag may comprise a certain, e.g. 2-D, structure or pattern, including but not restricted to text, that can be captured by the camera, for example.

The client device may be adapted, for example by an application running or intended to be run on the user device, to transfer or convert the captured structure or pattern, representing a certain type of code, into an electronic link. The electronic link may for example be a data link or data path enabling the client device accessing via an electronic network, e.g. the internet, electronic data in form of product information associated with the digital product information.

By providing the sensor readable tag, product information may be provided to a buyer, and also to subsequent users after purchase and delivery, of the appliance in a comparatively reliable and comprehensive form.

In particular, in cases where the buyer of the appliance has waived receiving product information in printed form and instead accepted, at the time of purchasing the appliance, to receive the product information in electronic form only, the appliance may be delivered to the buyer without the printed product information. Such a way of providing product information has some advantages, as for example cost reduction, conservation of resources as regards paper consumption, and similar.

In embodiments, the sensor readable tag may be selected in dependency of, or may specifically be adapted to the type of client device available to the buyer. For example, if the buyer, at the time of purchase, declares that he has a smartphone with a camera, a 2-D tag may be provided encoding a link to the product information of the appliance. Then, the buyer, or a subsequent user, of the appliance may, by photographing the tag with the camera and by operating the client device to transform the captured photograph into an internet link which may be accessed automatically by the client device using a web browser to thereby display to the user the product information in human readable form.

In case that other types of devices are available to the buyer or user intending to access the product information, e.g. an RFID reader and so on, a corresponding tag may be provided so that the buyer or user is able to access the product information using his device. In particular, the buyer may specify the type of device at the time of purchase, and the tag may be provided accordingly.

The user device, when accessing or when having accessed the product information may, either with or without user confirmation, provide for sending, for example to the vendor and/or manufacturer of the appliance, a confirmation indicating that product information for the appliance has been accessed and/or downloaded and/or read. The confirmation may comprise a user declaration indicating that he is aware of the product information.

In embodiments, for example a first step may be provided in which, by an electronic ordering system, a process of ordering, e.g. purchasing, the appliance may be supported or accompanied. In the process of ordering a buyer may place an order for the appliance and, in concert therewith, accepts receiving digital product information about the appliance. In preferred situations, the buyer may accept receiving digital product information only, whilst waiving his right to receive product information about the appliance in printed form.

The information obtained in the first step as regards the approval or agreement of the buyer to receive digital product information only may be transferred to and stored as a data item indicative of the buyer's approval. The stored information may be made available to manufactures and/or packaging companies and/or distribution or sales companies. Based on the information, respective entities are able to associate a corresponding sensor readable tag with the appliance prior to the delivery or handover of the appliance to the buyer. Thus, the buyer finally being provided with the appliance can readily access the product information based on the sensor readable tag.

In embodiments, which can be claimed separately, a method may comprise receiving at a computing device, preferably of an assembling and/or packaging entity, from an ordering system for ordering a kitchen or household appliance an indication that a buyer of the appliance accepts receipt of digital product information about the appliance. The method may comprise by the computing device, the step of generating or providing, based on the indication, access information indicative of how and where to electronically access the digital product information associated with the appliance. The method may further comprise, by the computing device, a step of providing or making available the access information for association with the appliance and/or a packaging of the appliance.

The step of associating the access information with the appliance may include at least one of attaching or gluing a label indicative of the access information to the appliance and/or packaging, imprinting a label indicative of the access information on a surface of the appliance and/or packaging, storing a data item indicative of the access information on a memory of the appliance. The access information may be associated with the appliance for example in form of a sensor readable tag.

In embodiments, a method in accordance with the present invention may comprise, by a client device of a user of an appliance, for example a household or kitchen appliance, activating a sensor and accessing a sensor readable tag, the tag being associated with, in particular provided on a surface of, the appliance, and, by the client device, reading out information provided by the tag.

The method further may comprise sending, by the client device, a request to a computing device identified by the read-out information and associated with a product information database having stored thereon digital product information for the appliance. The request may comprise the read-out information and/or an electronic link to a specific copy of product information.

In order to obtain the electronic link, the client device may be configured to process the read-out information and convert the read-out information into the electronic link, which may for example be a URL-link (i.e. Uniform Resource Locator link). The method may comprise the step of receiving, at the client device, a release note for enabling access to the product information, and, by the client device, accessing the product information and providing for display the product information on a display module of the client device.

The read-out information may comprise a type of authorization that may be checked by the computing device associated with the product information database as a prerequisite for allowing access to the product information.

In embodiments, the client device may send the information read out from the tag to a remote computing device and, as a result, may receive an electronic link to the product information. By following the received electronic link, the client device may access and retrieve for display to the user the product information associated with the electronic link.

In embodiments, the client device may be operable in accordance with any method described herein in that instructions in form of an application may be stored in a memory of the client device, which, when executed on the client device, cause the client device to perform the steps of the respective method. The application may, for example, be provided or transmitted to the client device as a result of a finalized purchase or order of an appliance. The order may be placed, by for example the client device, with an ordering system, e.g. a remote ordering system, associated with orders or purchases of the appliance. In particular, as a result of a finalized purchase, which may for example be obtained by sending, by the client device, a finalizing message to the ordering system, a link to or the application as such may be received by the client device and the application may be installed thereon, so as to be able to operate the client device, when running the application, in accordance with any method as described herein.

In embodiments, in a second step at least one of an assembling process or a packaging process of the appliance, which has been ordered in a previous step, may be carried out.

At least one of the ordered appliance, in particular kitchen or household appliance, or its packaging, e.g. an outer packaging, preferably the ordered appliance itself for example on an outer surface thereof, is provided with access information associated with digital product information for the appliance.

The access information, e.g. the link as provided by the sensor readable tag, may indicate how and where access to the digital product information related to the appliance is possible.

The access information may in embodiments be provided on a display section, in particular an electronic display section of the appliance.

Further, it may be provided that the access information is provided on a label associated for example with a product or type label of the appliance. In embodiments, a product or type label of the appliance may comprise access information, for example encoded access information, for accessing digital product information related to the appliance.

In embodiments, a third step may be provided that which may be implemented to support or provide in connection with an associated product information system assessment of the digital product information related to the appliance, e.g. the appliance ordered by the user. The user or buyer may also be designated a product information recipient that is enabled by the product information system, based on the access information provided for example in the second step, to access the product information.

In embodiments, it may be provided that the product information system allows accessing the digital product information via the Internet or any other suitable network, in particular including wireless or wire-bound, and also virtual private networks.

In embodiments, information may be collected related to the buyer's or customer's preferences of how to obtain product information. In particular, information may be collected and fed to a product information system, e.g. a database related to a product information system, related to preferences of the buyer regarding the product information of the purchased or ordered appliance.

In case that the buyer waives printed product information and agrees with obtaining solely digital product information, the sensor readable tag may be the only source associated with the product information provided together with the appliance upon delivery to the user.

For example, in an assembly process, in particular final assembly process, or final packaging process, which may be conducted subsequently to the order of the appliance, the appliance may be assembled and/or packaged, and, if for example waived by the buyer printed product information may not be added to the appliance. Instead, the appliance may be provided with access information, in form of the sensor readable tag indicating how to access product information related to and relevant for operating the appliance.

The method in particular may enable the buyer and/or user and/or product information recipient, which may be, for example, the end user, accessing the product information by using the access information provided together with the appliance as a link for electronically accessing the digital product information.

The product information may be stored, for example, in a data storage associated for example with a product information system. The product information system may be accessible via a data network, specifically the internet.

According to embodiments, in order to finalize an order process or purchase for the appliance, a confirmation tag may be set, e.g. by the buyer or purchasing system, indicating that it is required to provide or associate a sensor readable tag as discussed herein with the ordered or purchased appliance or product.

Specifically, an order form, which may for example be an electronic order form, e.g. presented to the user on a client device over the internet, may comprise a field or box that has to be ticked or checked in order to confirm that the buyer, end user, or information recipient is able to and is provided with a device for accessing and receiving digital product information instead of printed product information.

According to embodiments, the ordering system may be a fully automated ordering system or an ordering system that at least partly involves communication between persons. The ordering system may in embodiments comprise a central server computer or computing system and a plurality of client computers or client devices. The clients may comprise a user interface for providing an order form to the buyer or a regional distributor. For example, said client may be constituted by a data processing unit of the buyer, e.g. a tablet computer, smartphone or personal computer connected with the client via the Internet.

The client(s) may be configured to generate and transmit to the server via a network an order for an appliance, the order indicating, e.g. by a certain flag or parameter setting, that the buyer or user ordering the appliance has agreed with receiving product information on the appliance in electronic or digital form. The client may further be configured to add to the order information related to the type of digital information and/or information related to the type of client device, e.g. a smartphone, a tablet computer, a desktop computer, an e-book reader, the user or buyer of the appliance intends to use when accessing the digital information.

Clients associated with the user and/or buyer of the appliance may be operable to generate and transmit the order to the server and/or to capture or read out information comprised by the sensor readable tag associated with the appliance in accordance with order details related to digital product information.

According to embodiments, the method may comprise an additional step of delivery of the ordered kitchen or household appliance to either the buyer or product information recipient, wherein said additional step is performed between said second and said third step.

According to embodiments, said digital product information may comprise at least one of operation information or safety information for the ordered appliance. For example, the digital product information may comprise safety information to the extent as required by law in a country where the ordered appliance is delivered to said buyer or said product information recipient.

According to embodiments, said digital product information may be provided in at least one language identified during said first step. The at least one identified language may be an official language in a country where said ordered kitchen or household appliance shall be delivered. The at least one identified language may be an official language in a country where said ordered kitchen or household appliance shall be operated.

The at least one language may in embodiments comprise a language specifically selected by the buyer or user or person ordering the appliance. As an example, the at least one language may comprise a native language related to the buyer, user or information recipient. In case that the native language differs from the official language in a delivery country, and provisions prevailing in that country require providing product information in the official language, the digital product information may comprise both the official and native, i.e. user-desired, language version of the product information.

In embodiments, a client device may be configured to be operated such that at least one language comprised in the product information retrieved on the basis of the link provided by the sensor readable tag is selected on the basis of a language setting on the client device, a geographic location defined or determined by the client device and/or information comprised by the sensor readable tag. The geographic location may for example be determined on the basis of GPS (Global Positioning System), in that the client device comprises a GPS sensor operable to determine the geographic location.

The client device in embodiments may be operable, e.g. may comprise software which, when operated on a processor of the client device, causes the client device to add information regarding a language requirement as determined by the client device, for example on the basis of the geographic location and/or device settings, to a request generated for being sent to a server for retrieving the product information. The server receiving the request may assess and resolve the information related to the language requirements and may be operable to provide for transmission to the requesting client, product information comprising at least the language indicated by the language setting of the received request.

In embodiments, upon receipt of the product information and/or upon successfully downloading the product information, the client device may be operated to generate for transmission and/or to transmit to an entity, e.g. the server from which the product information had been received, a receipt confirmation evidencing receipt, in particular read receipt, of the product information. The receipt confirmation may comprise an ID or serial number of the appliance and/or may comprise information allowing the entity to identify or associate the confirmation with the buyer of the appliance.

The server or entity in embodiments may generate and store in a database information identifying the product information, comprising for example language(s) and version of the product information, provided for download and/or downloaded for a specific appliance. A specific appliance may be identified by the server or entity on the basis of a serial number and/or information associated with the buyer, transmitted to the entity or server, for example together with the request for retrieving product information on the basis of the information provided with the sensor readable tag.

In embodiments, the server may be operable to generate and send to the client device, a reminder notification in case that the server does not receive a receipt confirmation as regards receipt of the product information within a predefined time limit after delivery of the appliance to the buyer.

According to embodiments, in order to finalize the order process according to said first step, a confirmation by the buyer may be required. The confirmation may be intended to confirm that at least one of the buyer or the product information recipient is able to use or understand said at least one identified language.

According to embodiments, said digital product information may be specific for an actual or particular model of said ordered appliance.

According to embodiments, said second step, preferably at least said assembling process, may be performed by a manufacturer of said ordered kitchen or household appliance.

According to embodiments, the access information, for example provided as a link associated with the sensor readable tag, may be a code configured to be scanned by an electronic scanning device and/or electronic scanning module of a client device, such as for example a mobile user device.

The code may be a bar code, a QR-code or any other machine-readable code, including any 2D or 3D patterns or structures. By scanning said code, information regarding the product information of the household device may be obtained. Based on the obtained information which may be represented as a, or as a type of link, a download process for downloading the product information may be activated or started. For example, the client device may generate a request intended for transmission to a server, the request associated with accessing and retrieving the product information identifiable by the code or corresponding link.

The scanning device may be any device being capable of reading the access information. The scanning device may comprise a code scanner or a camera for reading the access information. Specifically, the scanning device may be a mobile phone, a smartphone or a tablet computer or at least a part thereof. For example the scanning device may comprise a camera module of a smartphone or tablet computer.

According to embodiments, after scanning said access information, product information associated with the appliance may be downloaded from a product information system, for example a product information server.

The access information, as already indicated, may provide a link, for example a direct link, to the product information to be downloaded, and/or the access information may initiate a search routine for searching product information being correlated with the appliance. The product information for the appliance may be obtained, e.g. downloaded, in an automated way.

According to further embodiments, and as already indicated further above, by scanning the access information by means of an electronic scanning device, language and/or geographical information may be gathered. The language and/or geographical information may be based on or associated with information available at the scanning device. A suitable language, for example a language required by legal requirements and/or according to user preferences, may be identified or selected on the basis of the gathered information.

For example, language information may be obtained by a language setting of the scanning device. Alternatively or additionally, the scanning device may comprise means for gathering geographical position data and the language of the product information may, by the scanning device or the server, be derived based on the geographical position data. Said means for gathering geographical position data may be constituted by a geographic position sensor, specifically a GPS sensor of the scanning device. Thereby, product information in a suitable language may be provided to the information recipient.

According to further embodiments, the access information may comprise information regarding the type or model of the appliance. For example, the access information may comprise information regarding the serial number or an equivalent identifier for determining the type/model of the appliance. Thereby, appropriate product information for the device may be automatically selected based on said access information.

According to further embodiments, the access information may comprise information regarding a service organization being available or responsible for service of the appliance. In case of a technical problem or in case that further information is needed, after scanning the access information, the customers service or information request may be forwarded to the service organization being responsible for service of the appliance.

According to further embodiments, the access information may be placed at the packaging of the appliance and/or at an outer surface of appliance. The access information may be an adhesive label being directly attached to the kitchen or household appliance and/or the package of the appliance.

The scanning device may be adapted to store the access information, for example only the coded label information or the label as a graphic file. After storing, the access information may be repetitively used. In case that the label can be removed and/or is or will be removed from the appliance or package, accessing the product information is still possible. In case that the label is intended to be removed, for example because it is provided on the packaging, a corresponding label may be provided on the appliance in a location where it is not mandatory to be removed. For example, the label may be provided on a back or lateral side of the appliance as regards the ordinary operational orientation. The label may for example be provided in connection with near a serial number and/or on a type label provided on the appliance.

According to further embodiments, the access information may be displayed at a graphical display of the kitchen or household appliance. The kitchen or household appliance may comprise a memory for storing information regarding the access information. By accessing the storage, the display may receive the access information data from the storage. With such embodiments, access information may be displayed or provided any time when a technical documentation or manual of the kitchen or household appliance is needed and/or, for example, requested by a user operating the appliance.

According to further embodiments, in case of a technical problem arising at the appliance, the access information may be displayed at a graphical display of the appliance, wherein the access information may further comprise or, by for example automated operation of the appliance, be supplemented with information regarding the technical problem.

In case of a technical error, the access information may be supplemented with information and/or an an error code. The supplemental information added to the access information and related to the error may, by scanning the access information, be submitted, in particular automatically submitted by a client device, to a technical support centre. As already mentioned above, the access information may also comprise information regarding the type/model of the kitchen or household appliance thereby enabling the technical support centre to provide optimized support services.

According to further embodiments, the order process according to said first step may comprise retrieving an email address by the ordering system. Thereby it is possible to provide additional information by email to a user, for example, a specific application for scanning the access information.

According to a second aspect, the invention also refers to a system for providing digital product information about an appliance, in particular electronic appliance, such as a kitchen or household appliance.

According to embodiments, the system may comprise an ordering system being adapted receive an order of an appliance and being adapted to retrieve information during the order process of the appliance that a buyer or product information recipient accepts receipt of digital product information about the kitchen or household appliance. In embodiments, the retrieved information may indicate that the user, buyer or other information recipient accepts receipt of only digital product information, meaning for example, that the user, buyer or information recipient waives receiving product information in printed form.

The system may in embodiments comprise an access information generating entity for generating access information to be placed, for example in form of a label, at the appliance or to be stored in a storage entity of the appliance in order to be accessible, in particular visible and/or displayable on a graphical display of the appliance. The access information indicating and/or comprising instructions, for example computer-readable or sensor readable or sensor recordable instructions, how to access the digital product information.

The system may in embodiments comprise a product information system for providing digital product information related to the appliance, for example a product information system adapted to provide for download the product information. The product information system may comprise a data interface for receiving, for example from a client device, said access information and/or a request to provide for download and/or transmission, e.g. to the client device, the product information. The product information system may be adapted to provide said digital product information of the appliance via the data interface based on the received access information.

The ordering system, for example a server or server system, may be configured to be operative to receive from a client device a purchase order of an appliance from a purchaser or dealer and to generate, based on information contained in the purchase order, access information to product information for the appliance. The access information may comprise a sensor readable, for example computer readable, link to product information stored in a product information database. The product information database may be part of or comprised by the ordering server or ordering server system. The system may be configured to transmit the access information, for example together with ordering information, to a manufacturing and/or packaging entity, e.g. to a receiving server or client of the manufacturing and/or packaging entity of the appliance.

A computing device, e.g. a server, server system and/or client device, of the manufacturing and/or packaging entity may be configured to be operative to receive, for example from the ordering system, access information associated with an ordered appliance. The computing device may for example be comprised by the ordering system. The computing may further be configured to generate and provide for applying the access information to the appliance and/or packaging of the appliance.

A client device of for example the purchaser of the appliance, which device in embodiments may, at least temporarily, be part of the ordering system, may be operable to access the access information provided on the appliance or packaging of the appliance and to automatically retrieve, from a computing device as describe beforehand, the access information based on a data link comprised in the access information. The client device may further be configured to provide for display to a user product information associated with the access information.

Referring now to a third aspect of the present invention, it has further been observed by the present inventors that the manufacturers of kitchen or household appliances in practice do not rely today on the ready use by their customers of code scanners, such as bar code or QR codes scanners, which are already today available as e.g. by code reader app on a smart phone of a customer, for providing to their customers via the Internet digital product information by putting corresponding bar codes or QR codes on their products. Rather, essentially all manufacturers today still prefer to provide printed user manuals with legally required safety and environmental product information with each delivered appliance. In fact, each user manual is frequently provided in a multitude of languages for each sold appliances, because the cost of providing a user manual in just the one language used by the customer of a given appliance is rendered unacceptable by logistic reasons.

The main reason for that wasteful practice has been identified by the present inventors as the concern of the manufacturers to fulfil their legal product information requirements. Said legal product information requirements have been recognized by the present inventors to in effect forbid the manufacturers to simply rely on a ready use of bar code scanners or QR code scanner by their customers for retrieving by themselves from the Internet the legally required product information, e.g. using a QR code app on their smart phone.

Contemplating further the reason for the above described newly-identified manufacturers' legal insecurity to use codes to be scanned by the buyer or product information recipient, in the following also referred to as user-scannable codes, on products as the major source for legally required product information, the inventors have observed a surprisingly simple reason. Namely that QR codes or bar codes have already been applied in many different contexts on kitchen and household appliances themselves, on their package, on their user manuals and in print media and advertisements, for example for advertisement reasons or for advertisement-related entertainment of customers. Now, the inventors have observed that said widespread use of user-scannable codes has avoided that bar codes or QR codes are readily appreciated by consumers as source for retrieving the definite specific product-information that is universally distributed via printed user manuals. In particular, since user-operable scanners for said codes have been available only for a relatively short time there has not been established so far any legally safe, i.e. any generally relied-on use in the market to provide legally-required safety or environmental product information via any code such as a bar code or a QR code. Therefore, placing any bar code or QR code as such on an appliance or on its packaging has been identified in the present invention as not sufficient for a manufacturer to meet the legal requirements to ensure that every customer safely receives the product-specific safety and environmental information.

Thus, the corresponding, previously unrecognized problem could be identified in the present invention as how to render a user-scannable code, such as e.g. a bar code or a QR code, a legally safe access information to product-specific digital information on a suitable user-accessible database, i.e. on the Internet.

According to the third aspect, the invention also refers to a system for providing digital product information about an appliance, e.g. a kitchen or household appliance, comprising digital product information about the appliance and access information, wherein the access information is adapted to be placed at a packaging of said appliance or to be placed at or displayed on the appliance itself or is provided on an appliance document about the kitchen or household appliance and the access information indicates how to access said digital product information about the appliance, and the access information comprises an indication in writing that it provides access to the product information.

According to embodiments, the access information can comprise a code, e.g. a bar code or a QR-code. The code can be adapted to be able to be scanned by a scanning device to provide access to digital product information. The access information may comprise in addition to for example a link to the product information, a written indication that it provides access to the product information.

The access information may be implemented as a unit that comprises both, a code that is configured to be scanned by an electronic device, e.g. as described herein with reference to bar codes or QR-codes, and an indication in writing that the accompanying code provides access to product information.

The written indication may be arranged and executed graphically to draw the attention of a user to the fact that that code provides access to important digital product information. For example, the code and the corresponding written indication can be arranged together on an adhesive sticker that can be attached at at least one suitable position of the appliance, such as in the region of a user interface and/or in a region where the type label of the appliance is usually arranged, such as a door edge.

Instead of or in addition to an adhesive sticker a printing comprising both the code and the corresponding written indication in a suitable common spatial arrangement may be applied to the appliance.

In alternative, or in addition, the code and, where appropriate, the corresponding written indication may be arranged together on a packaging of the kitchen or household appliance, such as a plastic foil wrap or a cartonage for transport.

As a further alternative or as an addition solution to the arrangement on the appliance itself and/or on its packaging, the code and, where appropriate, the corresponding written indication may be arranged together on an appliance document, i.e. on any papers that are delivered together with the appliance, such as an invoice, an order confirmation, a receipt or on a paper copy of a user manual, the latter especially if the buyer wants to have access to both, paper and digital product information.

As a further alternative or as an additional solution, the code or access information may be stored on a memory of the appliance. The appliance may be configured to present to the user on a display the code or access information. Displaying the code or access information may for example be executed upon start-up of the appliance, or may be executed upon receiving corresponding input from the user of the device, for example via a user interface.

In embodiments, the code and the corresponding written indication may be provided together in close arrangement to each other by optical display means of the appliance. For example, they can be shown together on a user display of the appliance or they can be projected by a projection unit of the appliance on a visible surface of the appliance or close to it. For example they can be projected onto a door of the appliance.

In embodiments the appliance may be adapted to be operable to automatically display the code and the corresponding written indication together in close arrangement when an operation problem of the appliance occurs and/or if the appliance receives a request from a user to display digital product information and/or upon an initial start-up and/or upon every start-up of the appliance.

In embodiments, the appliance may comprise a user interface configured to be operative, for example upon specific user action, to provide for display to the user the code or access information. By using the displayed code or access information, the user may be able, by using a corresponding client device, to access the product information. In case that a display provided on the appliance is sufficiently large, the appliance may be configured to be operable to provide for display the product information on the display of the appliance. In embodiments, the appliance, for example a user interface of the appliance, may be operable to either provide for display the code or access information or the product information as such.

In further embodiments, the system of the third aspect of the invention may comprise any of the features of the system of the second aspect and/or of the method of the first aspect of the invention, or the system of the third aspect may be considered to be an embodiment of the system of the second aspect of the invention.

According to a further aspect of the invention, a computer program product may be provided, comprising instructions which, when executed on a processor of a computing device executes the steps of a method according to any embodiment as described herein.

The terms “essentially”, “substantially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example schematic view of a kitchen or household appliance comprising access information;

FIG. 2 shows an example schematic flowchart of a method for providing product information to an information recipient; and

FIG. 3 shows an example schematic diagram of a system for providing product information to an information recipient;

FIG. 4 shows an example of a kitchen or household appliance comprising access information with a written indication that it provides access to product information.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

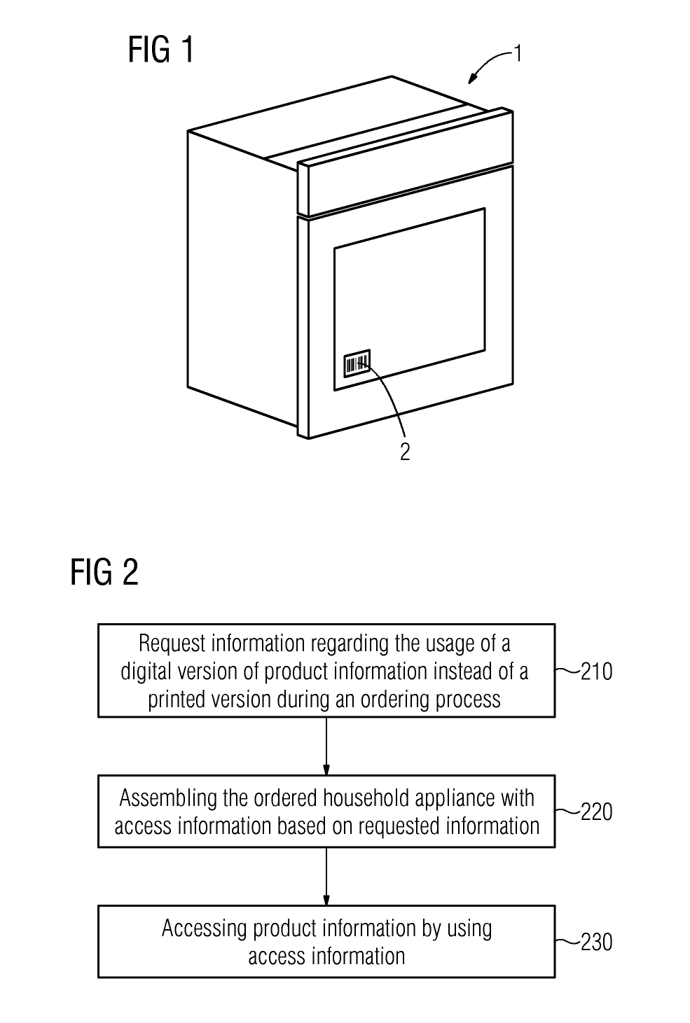

FIG. 1 shows a schematic diagram of a kitchen or household appliance 1, in the present example, a baking oven, such as for example an oven for a professional catering kitchen or an oven for a private household. Typically, kitchen or household appliances are delivered together with paper user manuals in paper form that comprise technical operation instruction information about the appliance, technical safety info and environmental information about the appliance. In the following, said information (user manual, environmental information etc.) is also referred to as product information. In order to avoid delivery of product information in paper from, the kitchen or household appliance 1 of the invention comprises access information 2 which can be used by an information recipient, especially the user of the kitchen or household appliance, but which may also be used by a technician to receive digital product information.

The access information 2 may be any kind of information being capable for providing a link to digital product information, for example, text, graphics or a code, for example a bar code or a QR-code. The access information 2 may be attached to the packaging of the kitchen or household appliance 1, for example, a foil being wrapped around the kitchen or household appliance 1, or may be attached to the outer surface of the kitchen or household appliance 1 etc. Also multiple attaching of access information 2 is possible. The access information 2 may be, for example, an adhesive label attached to the kitchen or household appliance 1.

According to a further example, the access information 2 may be stored in an electronic data storage entity of the kitchen or household appliance 1 and the kitchen or household appliance 1 may comprise an electronic graphical display for displaying said access information 2. Thereby, the access information 2 can be also provided at the kitchen or household appliance 1 without any optical impairment.

For accessing digital product information, for example, a digital version of a user manual, the information recipient or product information recipient may use the access information 2 as a link or hint to the desired digital product information. For example, the access information 2 may be scanned by a scanning device, for example a smart phone or a tablet computer, processed inside the scanning device in order to display digital product information of the kitchen or household appliance 1. For example, the scanning device may comprise an application (app) configured for accessing digital product information based on the scanned access information 2. In other words, after activating the application and scanning the access information 2, digital product information may be directly displayed at the scanning device.

Preferably, the scanning device comprises information regarding the language used by the information recipient or product information recipient. Said information may be derived by a language setting of the scanning device, geographical position data obtained by a position sensor (e.g. GPS sensor) of the scanning device etc. Based on the information regarding the language used by the information recipient, digital product information may be automatically displayed in a language which may be understood by the information recipient.

FIG. 2 shows the process of providing digital product information to an information recipient in closer detail. In order to avoid an undesirable shipment of printed product information, the buyer of the kitchen or household appliance has to decide whether he needs a printed version of the product information or not. So, during the order process, the order system may request information if the buyer wants to use a digital version of product information instead of a printed version (step 210). In particular, the buyer may be asked to confirm that no printed product information is needed. Preferably, the buyer may also be requested to confirm that he is able to access the digital product information, for example via internet. In addition, during the order process the email address of the buyer may be retrieved which is used for further communication, e.g. sending files, providing links or proposals for apps, specifically apps for reading/scanning the access information by the scanning device.

After placing the order, the ordered kitchen or household appliance may be assembled based on the retrieved information (step 220). Specifically, the kitchen or household appliance may be assembled with printed product information if the buyer does not want to use the digital version of product information. If a digital version of the product information has been acknowledged, the ordered kitchen or household appliance shall be assembled with access information providing a link to the digital version of product information. Said digital version of product information may be, for example, an electronic data file comprising said digital product information, specifically a pdf-file or the like.

As already mentioned above, the access information may be, for example, a code comprising information regarding the type and/or model of the kitchen or household appliance. Specifically, the access information may comprise information regarding a model, a PNC (product number code) and/or a serial number of the kitchen or household appliance in order to unambiguously determine the type and/or model of the kitchen or household appliance. Said assembling may also comprise the process of storing the access information within an electronic data storage means of the kitchen or household appliance in order to be able to display said access information at a graphical display of the kitchen or household appliance.

Finally, after delivery of the kitchen or household appliance, the buyer or product information recipient may access the digital product information by using the access information as a link to the digital product information (step 230). For example, the buyer, user of the kitchen or household appliance or any other product information recipient may scan the access information using a scanning device, the scanning device being adapted to retrieve digital product information of the kitchen or household appliance from a central data storage based on the information regarding the type and/or model of the kitchen or household appliance contained within the access information.

Preferably, the kitchen or household appliance may be assembled with an indicator or link, such as e.g. a bar code or QR code, for downloading an application, for example an app, to be stored at the scanning device. By means of said application or app, a scanning device, for example a mobile phone or a tablet computer comprising a camera, may be used for scanning the access information (by means of said camera) and displaying the digital product information associated with said kitchen or household appliance at a graphical interface of the scanning device. Said application or app may further be used for determining the language of the digital product information to be displayed, providing after sales information to the buyer, user or any other product information recipient, arranging a service visit or registration of the buyer, user or product information recipient and/or collecting feedback data from the customer after providing repair services.

In addition, the access information may also be used for contacting a service organization providing technical support for the kitchen or household appliance. For example, after scanning the access information, the buyer, user or product information recipient may be able to select whether he intends contacting the service organization or digital product information is desired. When contacting to the service organization is desired, the scanning device may transmit information regarding the type and/or model of the kitchen or household appliance to the service organisation in order to enable the service organization to provide specific technical support for the actual type of kitchen or household appliance. Furthermore, the access information may also be used for contacting the service organization responsible for supporting said type of kitchen or household appliance.

As already mentioned above, the access information may also be displayed at a graphical user interface, i.e. a graphical display of the kitchen or household appliance (for example, in addition to access information directly attached to the kitchen or household appliance, e.g. as adhesive label). Said displayed access information may comprise identical information as the access information attached to the kitchen or household appliance. In case of a technical problem of the kitchen or household appliance, additional error information may be added to displayed access information. The additional error information may be, for example, an error code indicating the occurred error of the kitchen or household appliance. In other words, in case of a technical problem, not only information regarding the type/model of the kitchen or household appliance may be included in the access information but also information regarding the occurred error. By scanning the access information a by means of the scanning device and forwarding said access information to a service organisation, the service organisation is able to provide detailed support information based on information regarding the type/model of the appliance and error information. In addition, said access information comprising error information may also be used by an technician at the customers site for getting precise information regarding the occurred failure, e.g. by means of a description in a service documentation which may be opened after scanning the access information. Also further information may be gathered by scanning said access information, for example, a spare part list or spare parts required for fixing the problem.

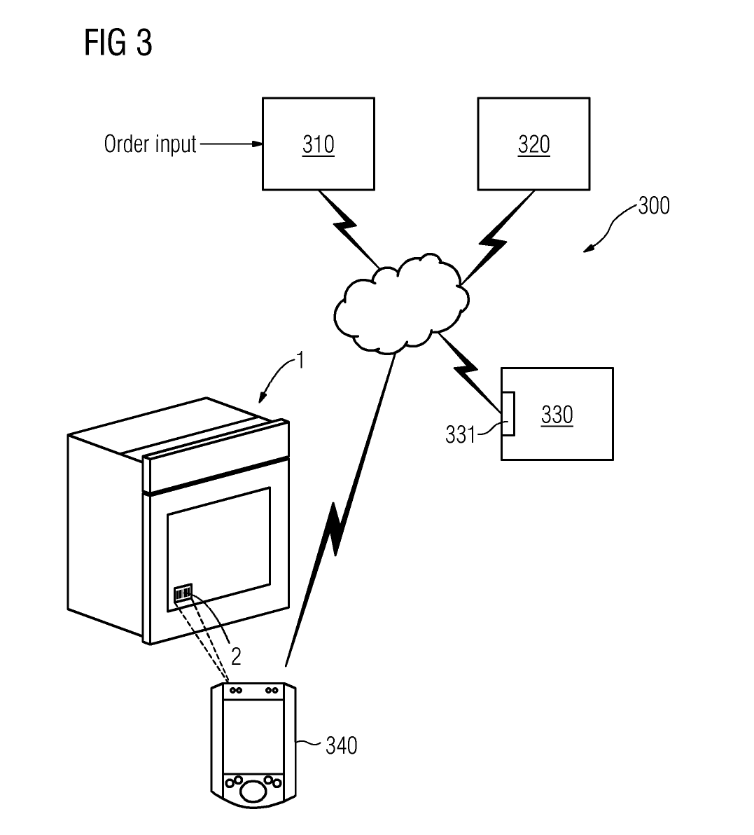

FIG. 3 shows a system 300 for providing digital product information of a kitchen or household appliance to an information recipient. The system 300 comprises an ordering system 310, an access information generating entity 320 and a product information system 330. The ordering system 310 is configured to retrieve information (order input data) during the order process of a kitchen or household appliance regarding using digital product information instead of paper form information from a person placing the order. For example, the ordering system 310 provides an order form to said person, said order form comprising a form field indicating if product information should be provided only in digital format.

If the person placing the order confirms that he does not require a printed version of product information, the kitchen or household appliance may be assembled without printed product information. The ordering system 310 may trigger the access information generating entity 320 coupled with the ordering system 310 via a data network to generate access information to be placed at the ordered kitchen or household appliance or to be stored in a storage entity of the ordered kitchen or household appliance in order to be displayed at a graphical display of the kitchen or household appliance, the access information indicating how to access the digital product information.

The digital product information may be provided by a product information system 330. The product information system 330 may comprise a data interface 331 for exchanging data with a scanning device 340 via a data network, e.g. via internet. After scanning access information at the kitchen or household appliance 1, the scanning device 340 may transmit a digital product information request comprising at least information regarding the type/model of the kitchen or household appliance 1 to the product information system 330. After receipt of the digital product information request, the product information system 330 may provide said requested digital product information data to the scanning device 340.

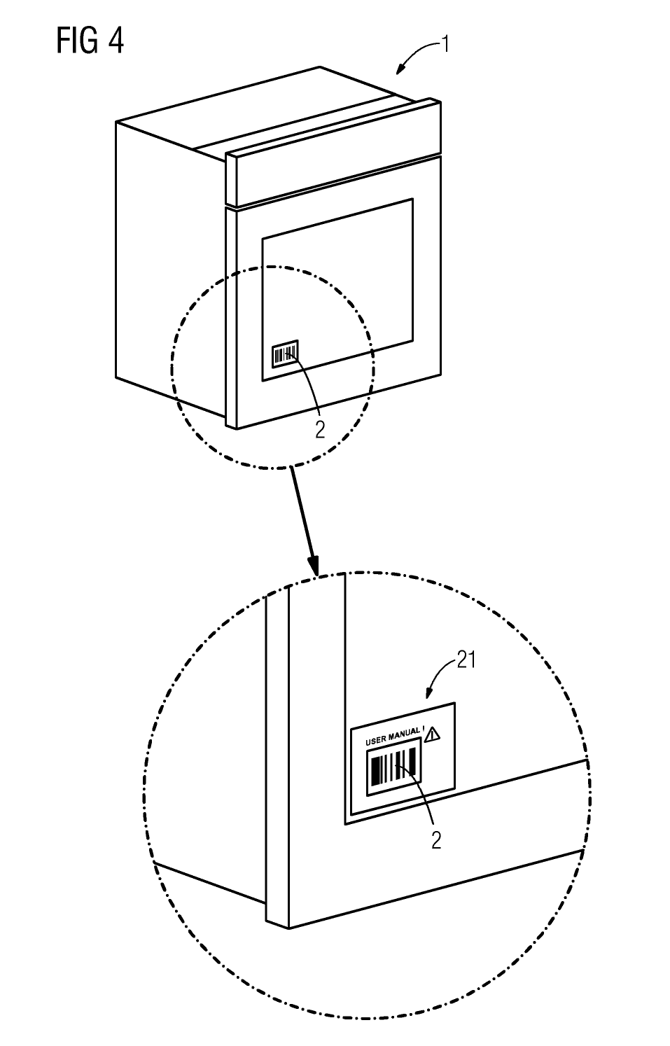

FIG. 4 shows an access information 2 that comprises a written indication 21 which are both arranged in close spatial correspondence to each other on the frontal side of a kitchen or household appliance 1. The access information 2 and the written indication 21 are arranged in suitable relation to each other to signal to a user that the code 2 provides access to important digital product information. They are both surrounded by a common graphical frame that indicates that they refer to each other. In the shown example they may, for example, be comprised on a common adhesive sticker or formed by printing as a common label, or they may be produced optically by an electronic display means of the appliance that has a sufficient resolution to display a code such as a bar code or a QR code that can be effectively scanned by a scanning device.

Above, embodiments of a method and a system for providing digital product information to a user of a kitchen or household appliance according to the present invention as defined in the appended claims have been described. These should be seen as merely non-limiting examples. As understood by a skilled person, many modifications and alternative embodiments are possible within the scope of the invention.

### LIST OF REFERENCE NUMERALS

1 household device
2 access information
21 indication in writing
300 system
310 ordering system
320 access information generating entity
330 product information system
331 data interface
340 scanning device

1. Method for providing digital product information about a kitchen or household appliance (1), the method comprising the consecutive steps of:
as a first step, supporting by an ordering system (310) an order process of the kitchen or household appliance (1), during which a buyer places an order for said kitchen or household appliance (1) and accepts to receive digital product information about the kitchen or household appliance (1);
as a second step at least one of an assembling process or a packaging process of the ordered kitchen or household appliance (1) ordered in the first step, wherein at least one of the ordered kitchen or household appliance or its packaging, is provided with access information (2) that indicates how to access said digital product information; and
as a third step supporting by a product information system (330) an accessing of the digital product information about said ordered kitchen or household appliance (1) by at least one of said buyer, information recipient or product information recipient based on the access information (2) provided in the second step.

2. Method in particular according to claim 1, comprising:
receiving at a computing device, of an assembling and/or packaging entity from an ordering system (310) for ordering a kitchen or household appliance (1) an indication that a buyer of the appliance accepts receipt of digital product information about the appliance (1);
based on the indication, generating, by the computing device access information (2) indicative of how and where to electronically access the digital product information, and
by the computing device, providing or making available the access information for association with the appliance and/or a packaging of the appliance, wherein associating the access information with the appliance includes at least one of attaching or gluing a label indicative of the access information to the appliance and/or packaging, imprinting a label indicative of the access information on a surface of the appliance and/or packaging, storing a data item indicative of the access information on a memory of the appliance, the access information being associated with the appliance in form of a sensor readable tag.

3. Method according to claim 1, wherein in order to finalize the order process according to said first step, a confirmation by the buyer is required that at least one of the buyer or said product information recipient is able to access said digital product information, and/or wherein the ordering system is a fully automated ordering system (310) or an ordering system at least partly involving communication between persons.

4. Method according to claim 1, comprising an additional step of delivery of the ordered kitchen or household appliance (1) to either said buyer or said product information recipient, wherein said additional step is performed between said second and said third step.

5. Method according to claim 1, wherein said digital product information (2) comprises at least one of operation information or safety information for the ordered kitchen or household appliance (1), wherein at least providing said safety information is required by law in a country where the ordered kitchen or household appliance (1) is delivered to said buyer or said product information recipient.

6. Method according to claim 1, wherein said digital product information (2) is provided either only, or in at least a prominent delivery form in at least one language identified during said first step, wherein said at least one identified language is an official language in a country where said ordered kitchen or household appliance (1) shall be delivered, wherein said at least one identified language is an official language in a country where said ordered kitchen or household appliance (1) shall be operated.

7. Method according claim 6, wherein in order to finalize the order process according to said first step, a confirmation by the buyer is required, in order to confirm that at least one of the buyer or the product information recipient is able to use said at least one identified language.

8. Method according to claim 1, wherein said digital product information is specific for the actual model of said ordered kitchen or household appliance (1) and/or at least said assembling process is performed by a manufacturer of said ordered kitchen or household appliance (1).

9. Method according to claim 1, wherein said access information is a code being configured to be scanned by an electronic scanning device, wherein after scanning said access information (2), digital product information is downloaded from a product information system (330).

10. Method according to claim 9, wherein by scanning the access information (2) by means of an electronic scanning device (340), language or geographical information relating to the buyer or product information recipient is gathered by the ordering system (310) based on information available at the scanning device (340) and a suitable language is identified based on said information.

11. Method according to claim 1, wherein the access information (2) comprises information regarding a service organization being available for service of the kitchen or household appliance (1).

12. Method according to claim 1, wherein said access information (2) is placed at a packaging of the kitchen or household appliance (1) or at an outer surface of the kitchen or household appliance (1) and/or the access information (2) is displayed at a graphical display of the kitchen or household appliance (1), wherein in case of a technical problem of the kitchen or household appliance (1), the access information (2) displayed at a graphical display comprises further information regarding the occurred technical problem.

13. Method according to claim 1, wherein the order process according to said first step comprises retrieving an email address by the ordering system (310) for providing additional information to at least one of said buyer or said product information recipient.

14. System for providing digital product information about a kitchen or household appliance (1), the system (300) comprising:
an ordering system (310) being adapted receive an order of a kitchen or household appliance and being adapted to retrieve information during the order process of said kitchen or household appliance (1) that a user, buyer or product information recipient accepts to receive digital product information about the kitchen or household appliance (1);
an access information generating entity (320) for generating access information (2) to be placed at the kitchen or household appliance (1) or at a packaging thereof or to be stored in a storage entity of the kitchen or household appliance (1) in order to be displayed at a graphical display of the kitchen or household appliance (1), the access information (2) indicating how to access the digital product information; and
a product information system (330) for providing digital product information of the kitchen or household appliance (1), the product information system (330) comprising a data interface (331) for receiving said access information (2), the product information system (330) being adapted to provide said digital product information of the kitchen or household appliance (1) via the data interface (331) based on the received access information (2).

15. System (300) for providing digital product information about a kitchen or household appliance (1), according to claim 14, comprising digital product information about the kitchen or household appliance (1) and access information (2), wherein the access information (2) is adapted to be placed at a packaging of said kitchen or household appliance or to be placed at or displayed on the kitchen or household appliance (1) itself or is provided on an appliance document about the kitchen or household appliance, the access information indicates how to access said digital product information, and the access information (2) comprises an indication in writing (21) that it provides access to the product information, wherein the access information comprises a user-scannable code, specifically a code scannable by a buyer or product information recipient.

16. Computer program product, comprising instructions which, when executed on a processor of a computing device, executes the steps of a method according to claim 1.

17. Method for providing digital product information about a kitchen or household appliance (1), the method comprising the consecutive steps of:
as a first step, supporting by an ordering system (310) an order process of the kitchen or household appliance (1), during which a buyer places an order for said kitchen or household appliance (1) and accepts to receive digital product information about the kitchen or household appliance (1);
as a second step at least one of an assembling process or a packaging process of the ordered kitchen or household appliance (1) ordered in the first step, wherein at least one of the ordered kitchen or household appliance or its packaging is provided with access information (2) that indicates how to access said digital product information
wherein no printed user manual is included during the packaging process of a kitchen or household appliance and the resulting packaged kitchen or household appliance is transferred without any printed user manual to a warehouse;
as an intermediate step between said second step and a later third step, preparing for delivery to said buyer said kitchen or household appliance ordered in the first step, the intermediate step including picking a packaged kitchen or household appliance of the second step that does not comprise any printed user manual from the warehouse, determining whether said buyer has accepted or not in the first step to receive only digital product information, and a printed user manual is still added to said packaged kitchen or household appliance prior to its delivery to said buyer as said kitchen or household appliance ordered in the first step based on said determining only in the case that the buyer has not accepted to receive only digital product information;
as a third step supporting by a product information system (330) an accessing of the digital product information about said ordered kitchen or household appliance (1) by at least one of said buyer, information recipient or product information recipient based on the access information (2) provided in the second step.

18. Method according to claim 1, wherein the buyer accepts to receive only digital product information; the ordered kitchen or household appliance itself is provided with the access information (2) that indicates how to access said digital product information; the ordered kitchen or household appliance (1) is adapted to display said access information (2); and said product information system (330) allows to access said digital product information via the Internet.

19. System according to claim 14, wherein the buyer accepts to receive only digital product information.

20. Method according to claim 17, wherein the buyer accepts to receive only digital product information; the ordered kitchen or household appliance itself is provided with the access information (2) that indicates how to access said digital product information; the ordered kitchen or household appliance (1) is adapted to display said access information (2); all kitchen or household appliances are packaged and transferred to a warehouse without any printed user manual; said determining is automatically executed by a computing device; and said product information system (330) allows to access said digital product information via the Internet.
